(19) United States
(12) Patent Application Publication
(10) Pub. No.: US 2024/0373777 A1
(43) Pub. Date: Nov. 14, 2024

(54) System and method for managing life sustaining bio-systems

(71) Applicant: Richard Postrel, Miami Beach, FL (US)

(72) Inventor: Richard Postrel, Miami Beach, FL (US)

(21) Appl. No.: 18/445,176

(22) Filed: May 8, 2023

(51) Int. Cl. A01B 79/00; B82Y 15/00; G06Q 50/02

(52) U.S. Cl. CPC A01B 79/005; B82Y 15/00; G06Q 50/02

(57) ABSTRACT

The present invention teaches systems and methods for managing life sustaining bio-systems, both here on earth and in the exploration and colonization of space. The technology disclosed herein, allows for the analysis of organic and non-organic compounds as they relate to the management and optimization of food production, oxygen production, and other elements necessary to support sustainable habitats and maintain healthy biospheres. This invention also allows for large scale terrestrial, oceanic, and atmospheric analysis suitable for agricultural development and optimization, management of water resources and humidity, carbon and other industrial emissions, municipal and agricultural pollution, urban and field pest mitigation, and climate altering impact(s). The primary goal of this invention is to eliminate food insecurity while improving the sustainability of our planet. A secondary goal is to assist humankind in the exploration of space.

The present invention teaches systems and methods for managing life sustaining bio-systems, both here on earth and in the exploration and colonization of space. The technology disclosed herein, allows for the analysis of organic and non-organic compounds as they relate to the management and optimization of food production, oxygen production, and other elements necessary to support sustainable habitats and maintain healthy biospheres. This invention also allows for large scale terrestrial, oceanic, and atmospheric analysis suitable for agricultural development and optimization, management of water resources and humidity, carbon and other industrial emissions, municipal and agricultural pollution, urban and field pest mitigation, and climate altering impact(s). The primary goal of this invention is to eliminate food insecurity while improving the sustainability of our planet. A secondary goal is to assist humankind in the exploration of space.

This invention applies multiple types of nanosensors adapted for diverse environments including, but not limited to terrestrial, atmospheric, oceanic, and deep space applications. The present invention provides a tracking system that enables early warning and early response mechanisms relating to changes in an observed location of interest. The system features devices and algorithms for recording, analyzing, and managing the bio-health of ecological niches, biospheres, self-contained farms, planetary environments, and designated areas for preservation, etc. Primary concerns of the system are events that can materially impact the balance of earth's atmosphere such as massive methane releases from thawing permafrost and oceanic hydrates, greenhouse gases and other compounds from microbes—including, but not limited to soil, water, swamp and gut microbes, etc. Other concerns include general health of: tundra, coniferous forest, deciduous forest, tropical rainforest, temperate rainforest, boreal forest, grassland, intertidal zones, savanna, cold desert, hot desert, mountain desert, chapparal, glacier, polar region, mountain, coastal regions, wetlands, freshwater ponds, streams, lakes, ocean surface, ocean depth, etc., biomes. Each may be specifically managed and managed for positive impact on other biomes. In established biomes the carbon sensor based data may detect presence of an invasive species that may guide biome management.

Organic and inorganic compounds in these biomes are monitored with specialized sensors that preferably include graphene carbon and single wall-carbon nanotube (SWNT) nanosensing elements. Such sensors and more conventional sensing elements may incorporate satellite based, earth based, balloon based, sea and undersea based, drone based, subterranean based, etc., sensing platforms. The carbon based sensing elements are disposed at a site of interest where they monitor ambient compounds close to the organisms of interest. Data from other sensing elements, e.g., light/color—visible and invisible, temperature, wind or water flow, ocean temperature, weather forecast models, magnetism, electric field, solar flare, ozone layer, etc., preferably are consolidated with the data obtained from carbon based sensing elements to provide a more robust data set that will improve reporting and management algorithms. Almanac data such as sunrise/sunset, high and low tides may also be helpful in some applications. For example, carbon based sensors may detect specific insect pheromones. Temperature data may be used to predict breeding and growth rates; light levels day-night timing may predict optimal time for mitigation efforts; presence of other insect pheromones—potentially from carnivores of the problem insect may guide ameliorative efforts. Management may include managing (optimizing) the carnivore population possibly including new carnivores to the infested area. Weather and wind flows may indicate the routes and severity of an insect plague. Just the carbon based sensor data alone provides a solid basis for the analysis and management, e.g., optimal harvest time based on plant maturity (but weather may suggest an earlier harvest if the storm would significantly impact yield or ability to market).

Coastal region management and seafood farms benefit both from SWNT and graphene based sensor data. The health of plants anchoring the beaches, marshlands and dunes may be analyzed to determine optimal management for coastline and wetland management. Additional data, such as the timing of high and low tides, water temperature, currents, impending storms may be used for immediate intervention decisions. Seafood farms, e.g., oyster, salmon, lobster, etc., can have the surface air VOCs analyzed for overall health of the food population, uptake of feed, presence of predators or pathogens, etc., for general farm management. Trace element or vitamin supplementation can be optimized from these data. Water temperatures, current flows, tides, and other data may help predict waste clearance, nutrient delivery and removal from and by the sea or ocean current, etc. Presence and health of wild species, such as fish, plankton, seaweed, shellfish, and their food chains may be monitored and analyzed for sustainable harvest.

A person or team in receipt of analyses obtained from practicing the present invention is able to respond to early or small infestations to greatly reduce spread of the infestation to greatly reduce management costs to increase yields or to improve sustainability of managed areas.

History includes multiple instances of plagues and blights that have significantly impacted the human populations. Today we have a better understanding of underlying biological causes including, but not limited to: arthropods, fungi, bacteria, etc. (pests). Early detection of budding infestations allows us to respond promptly and inexpensively to emerging threats. Delay of several days or weeks permits the exponential pace of breeding to increase the numbers and often the range of pests. “Pests” is used as a term to include invasive organisms or those that are out of balance with their natural environment.

Pests may be detected by ground observations, e.g., a farmer in the field observing diseased crops. Reports from several farmers will be necessary to understand the extents of pest damage. Aerial observation, including satellite monitoring, is used on a grander scale and now can be used to identify failing crops whether pest, drought or temperature induced. These aerial observations are often confirmed by ground observations. Generally, significant spread has occurred before the nature of the failing crops is determined. “Crop” is used in a general sense encompassing not only seasonal or annual plantings for one-time harvesting, but also any field or habitat or area of interest including, but not limited to: a grassland, a wetland, a prairie, a desert, a forest, a rainforest, a steppe, a savanna, a meadow, a park, a pasture, a nursery, a greenhouse, a rack, a shelf, etc., and any animals dependent on such “crop”.

VOC analysis, by indicating status of the crop, not only may indicate maturity or ripeness for harvesting, but also may follow the crop to market or other disposition. For example, if a crop is to serve as feed for a downstream crop, VOC analyses of the feed and recipient can optimize results from both crops. Improving downstream crop management reduces the amount of upstream crops needed for managing those downstream requirements and allows better utilization of existing resources. Continuous downstream VOC analyses may extend to the retail supermarket, or, optionally with other data consideration, may be used to divert crops to alternative destinations, for example where a greater need arises, or for processing as fresh food, frozen food, canned food, fish food, fertilizer, etc.

The present invention meets a recognized need through provision of tools and responses for detecting localized or spreading infestations when they are at a nascent more easily managed stage which relies in part on an understanding that species and strains of species differ from one another.

Each plant and animal species has evolved into its own niche. The speciation process has resulted in characteristic metabolisms (enzymes and controlling genes) specific to the species. The numerous biochemical reactions that comprise these metabolisms share similarities between similar organisms, but the different genes expressed in different species drive a unique collection of reactions specific to a species responding in concert with local environmental factors. These metabolic reactions produce characteristic molecules including a class of molecules known as volatile organic carbons (VOCs). Each of these metabolic consolidations of related events in metabolism will produce volatile organic compounds (VOCs) as beneficial signals or as side products of reactions.

Different pests attacking or feeding off the same crops may be competitive (one dominates over the other in that field) or non-competitive (feeding off, e.g., root rather than leaf); or feeding at different stages of target maturity. For example, a pine tree may emit VOCs. indicative of general insect attack stress while the attacking species VOCs in the surrounding air will be available to identify the responsible species. These VOCs in combination may signal surrounding trees to initiate anti-insect defenses which may not be sufficient to control the infestation. When the pest is out of balance intervention by man may save the forest. For man to assist in attacking an insect infestation requires that the attacking species be correctly identified. For example, of the five species of the pine beetles commonly attacking southern US forests each requires different control strategies.

Some VOCs are very noticeable as body odor in larger animals and as scents in plants. The smells of fresh cut grass and flower blossoms are easily perceived examples of VOCs. This invention analogizes the importance of olfactory senses to survival and produces a highly sensitive, dynamic, teachable, easy to reference report, especially when an alarm might be raised, e.g., an insect or fungal infestation is a field.

While the art has identified about three dozen VOCs emitted by locusts, only six were featured in emissions from insects present in swarms, but not by solo insects. One compound, 4-vinylanisole, was also found to be a strong attractant to both male and female locusts and acted as a positive feedback for swarming. OR35 (olfactory receptor 35) in the locust is activated by 4-vinylanisole and appears essential for the swarming process. This collection of data and analysis supporting these findings was intricate and time-consuming. Several labs worldwide dedicated significant hours of researcher time at considerable expense to identify the compound, 4-vinylanisole, as a harbinger of swarming and potential tool or target for swarm control.

Mosquitos and several other pests have been exhaustively analyzed with a general finding that insects tend to produce signal VOCs specific to the species. Fungi and other pests also have been found to produce VOCs as metabolic byproduct or as pheromones specific to the organism.

Plants also produce signaling VOCs as a survival strategy. Under attack, a plant may produce a stress hormone/pheromone released into ambient air to signal nearby plants. The signal may induce nearby plants to instigate protective measures such as manufacturing a pest repellant or a natural pesticide. Some plants release pheromones that act as attractants to other species such as insectivores.

This background serves as a teaching that VOCs when detected can signal pest infestation and provide for prompt mitigation when areas can be precisely targeted with costs and collateral environmental damage minimized. However, a study for each plant and pest species to identify species specific signals would require a massive effort.

The present invention thus provides capacities for monitoring at least hundreds of thousands of volatile compounds (i.e., compounds that are liberated as gas molecules into the ambient surrounds of the organism, plant, or pest). Gas sensing elements may be protected from weather and water using a protective case or more simply covering with a selective membrane permeable to gasses but not to liquid substance. The present invention features sensing elements on a micro-miniature, e.g., micrometer or nanometer scale. Sensing elements in a range of 10 s of nanometers and larger can be included in devices disposed on any solid object, e.g., on a fence post, on a tree trunk or branch, on a stalk, on a fence crossmember, on a stake or post, on a wire, on a ground based robot, on a farm implement, on a low altitude drone, on a watchdog, etc. For example, a single stake may include sensor pods at one or more subterranean depths, a low, ground level (e.g., stalk), and up though leafy, flowering or fruity levels on higher to pods sensing one or more levels of ambient air above the crop(s). Both graphene and SWNT carbon based sensor elements may be present as well as other sensors such as humidistats, thermometers, etc. Embodiments may include a stake bearing a continuous or pseudo-continuous sensing strip along a length of a stake. Controlling the depth of penetration of each stake is obviated when sensors along the strip can be selectively activated as indicative of subterranean, plant level and higher ambient air reporters. A preferred embodiment features modules or sections that may be integrated end-to-end to adjust length and thereby conform to any specific local needs.

Section lengths are chosen for portability, packaging, weight, handling, or other selected design component. Sections or the entire sensing component may be covered with a removable protective sleeve for transport or during implementation. Sensors may not be present in every section. For example, a bottom fixture may serve as a drill bit to facilitate insertion into ground or another solid base. Sensor modules may be incorporated sectionally, e.g., just above the bit for underground sensing; a spacer may separate this from a sensor at the ground air interface; any number of spacers or sensors may be stacked to provide data at chosen heights; a section may top the post to allow accessibility, visibility, or line of sight communication to a remote sender/receiver. Components and spacers are not necessarily the same lengths. Each may be available in several lengths. For example, spacers or segments may be approximately 15 cm, 20 cm, 25 cm, 30 cm, 35 cm, 40 cm, 0.5 m, 1 m, 2 m, etc. as desired for the specific application. The modules may attach using any connection known in the art to permit communication and integrity. Fittings may be screw-in, spring clip, plug-in, toggle attachment, hook and eye, or other securing method as desired.

The large number of independent sensing elements goes a long way to providing for signature discrimination. That is, the readouts from the collection of sensors can be collected, stored and processed to produce a multidimensional signature taking into account signals reported from a plurality of sensors. The processor can produce ratios and other relationships between multiple sensor outputs for storage in a memory center. An artificial intelligence component in the processing may manipulate the data from different sensors, perhaps assigning strength to sensor outputs to weigh importance and produce an output analogous to a ratio. Massaged data from a sensor element may itself contribute as an additive or multiplicative factor to be applied to outputted data from another sensor. Strength factors may be negative or positive. Combining sensor output analyses with other sensor output analyses and additional historical or contemporary data including, but not limited to: VOCs from nearby fields, polluting factories, roadways, forests, proximity to a road or river, pesticide application, herbicide application, fertilizer application, irrigation, historical aberrations, location, temperature, humidity, time of day, type of crop, seed source, historical use of the field, solar radiation, cloud cover, pH, soil moisture, nitrogen concentration, phosphorus concentration, date of planting, crop price, conditions in comparison crop dispositions, rainfall, weather forecast, and windshear, etc.

One or more central processors may consolidate communications originating from a plurality of dispersed sensing devices. A central processor may communicate instruction to sensors to modify sensing factors, e.g., changing the base voltage of a sensing element. Processors may control non-sensing features of one or more devices, such as by physical orientation of the device (e.g., tilting), directing air flow through a selected filter; controlling ventilation volume by opening an access flap or in some embodiments controlling a fan if one is present.

When desired, a post or stake may be capped with one or more accessories. For example, a cap may be color, shape or otherwise coded to indicate qualities of the underlying post. A solar collection apparatus may collect power for the power consuming components on the post. Such cap might include a local processor or may feature a radio and antenna for communicating with a central processor. Such cap may be rotatable to maximize power collection or directional sensing, e.g., of moving air, light or sound. Preferably these data are memorialized in a memory storage center to support historical analysis.

Sound may be dispositive for identifying some pests or pest herbivores or carnivores. Microwaves or other electromagnetic waves may serve to provide power and/or may contribute to the communication and data analysis processes. Sound may also serve as a tool for analysis or mitigation. For example, when one or more pests are suspected, e.g., based on VOC sensor data, a sound associated with one on the pests may be broadcast to elicit response. Responses resulting from the sound may serve to differentiate between pests that may otherwise have similar signature patterns. Sound mitigation is known to occur on a gross scale when cannon sounds drive crows from a field. Sound may also be more finely tuned, e.g., to attract or repel pests or pest carnivores, to confuse mating or other signaling, etc.

Such cap, with a potential “bird's eye” view may include other (non-chemical) sensing abilities. Such cap may include a still or video camera for monitoring a field. The camera need not be high resolution, but might be configured only to sense motion (animal, wind, presence of unexpected items, etc.), light absorbance and reflection (color), or may be configured for sensing heat (warm blooded animals, developing frost conditions, etc.). Preferably, video data is recorded at the source or transmitted to an associated data storage device for data retention.

Sound or video sensing and/or recording associated with primary devices of the invention, may contribute other benefits, such as detecting and serving as evidence for trespass events, such as theft, accident, toxic or other dumping, etc.

Posts may be manually disposed or may be dispensed using mechanical means. Posts may be implantable with materials selected for durability at the discretion of the installer. For example, treated or untreated wooden posts, posts with metal or plastic portions or coverings, plastic posts, metallic posts, or posts comprising a combination of materials may be outfitted with one or more pods of sensing elements, one or more bands of sensing elements, one or more strips, or a combination of arrangements of sensing elements. Posts or post accessories may incorporate additional sensing devices including, but not limited to: thermometers, microphones, photometers, cameras, etc. Where implantation depth is considered relevant, posts may be marked to indicate proper insertion. Posts may be telescopic for easier transport or packaging or to permit length or height adjustment when desired. Posts may be ruled with gradations to indicate depth of implantation or heights above ground or of a telescoped section. Mechanical implanters including, but not limited to: electromagnetic rail guns, springs, levers, rotating wheels, pistons, aerial drops or landings, etc., may be used to plant devices to a predetermined or variable depth. Sampling may be distributed as desired by a person involved in data collection. For example, posts or other sensor substrate media may be placed at or a predetermined distance from an edge of the plants of interest. They may be disposed in a grid pattern; may be disposed radially, may be disposed at higher densities in areas where extra scrutiny is desired; may be disposed along a geologic feature such as a stream bed, a valley bottom, a hillcrest, a roadway; etc.

Just as similar pests may share similarities in signature patterns, data obtained from similar crops may be incorporated into memory centers and accessed for comparison and building algorithms to address crop health or state of maturation or attack or infestation from a pest. Crops may share similarities in transgenes or in natural genes. For example, desired genes may be transgenicly inserted across a diverse set of crops. Related strains or species will share many metabolic traits and thus provide valuable comparative data. Especially when crops share a market, e.g., different strains of wheat, and thus can serve as economic substitutes, historical breeding may have inserted and maintained shared traits. This may be a sign that data from these distinct but similar species or strains can provide valuable signature pattern comparison data. When crops share a gene relevant to a VOC or other data point, this similarity may contribute to building and improving associated algorithms.

Sizes of individual sensing elements may be made, for example in a cross sectional size ranging from less than 50 nm to perhaps 1 mm or more, for example about, 40 nm, 50 nm, 75 nm, 100 nm, 200 nm, 250 nm, 500 nm, 0.5 μm, 1 μm, 5 μm, 10 μm, 50 μm, 100 μm, 200 μm, 500 μm, etc. Shapes may be planar, essentially flat on the substrate surface, or at an angle disposed off the surface. Even if essentially flat, the small size of the sensing elements allows fixation onto curved surfaces, such as a wrap around, or in a tape or in a fabric or flag. Shapes may be irregular, e.g., crumpled or creviced. Shapes may be regular, e.g., hexagonal, creviced, etc.

The sensing elements can be distributed at high density. For example, with a sensor size of 50 nm spaced 50 nm apart, a 1 mm pod of sensors can include 100,000,000 (10⁸) sensing elements. The extremely high number of available elements allows for redundancies in the case where a sample is damaged or improperly formed in manufacture. Sensing elements can function in vacuum or high pressure. The interaction of VOCs, freely mobile molecules in a gas state, does not require carrier gas or liquid. Sensors, e.g., sensors mounted on posts, pods, balls, or any desired substrate shape, might be disposed as sentries for inhospitable areas, such as comets, asteroids, or other near or deep space objects of interest. VOCs from these targets may or may not be indicative of a life form, but carbon containing compounds associated with such foreign bodies can help to explain the source and history of the object including present or previous habitations. In the future, such nanosensing elements may be used to assess possible sites for off earth colonialization. On earth or in space nanosensing elements permit disposition of a very large number of differently tuned sensing elements to provide detailed assessments and differentiations of VOCs and other molecules that briefly interact with each element.

The sensors having been placed in the field or area of interest require minimal power. The processors are expected to be rather robust and thus will require more power. Sensor pods may be configured with a self-contained battery pack. The processor and sensing pods, if desired, may generate renewable power from any suitable means known in the art. For example, a solar panel or turbine generator may power the devices.

The sensors communicate with a local or a central processor. Some processing may take place in association with the sensing pod and its substrate. Such processor may be tightly integrated with its pod, for example, sharing a casing or circuitry. Or a local processor may be connected by wire or wirelessly to its sensing cartridge. A sensing pod itself need not comprise a communications portal for communicating with a central processor. Such pod may connect through a portal configured as a separate module or may attach through an accessory component that may be slightly remote, but may have better access to power, such as a solar exposure, or allow for stringing a better antenna.

Duplicate, triplicate, or greater sensing chip redundancies may be placed on a single sensing device. Redundancies in communications can support longevity, sustainability when damaged, and analytical performances. Local processors may communicate with neighbor local processors and/or processors in more distant locations with similar functions. Communications may be designed into the sensing device structure, such as summation or amplification.

Preferred primary sensors of the present invention comprise “chips” with modular nano-sensing elements (or nano-sensor element (NSE) that are independently maintained at a fixed,. fluctuating, stochastic, alternating, discontinuous or flashing feeder power. Chips may be configured essentially on a two-dimensional substrate. Chips may be stacked one atop another to differentiate between ground sourced and ambient atmosphere data. Other available formats include but are not limited to: a tubular structure (e.g., a two dimensional substrate bent to form a tube), a linear or strip format (essentially one-dimension) that may be made two-dimensional when a plurality of strips are side-by-side, a fibrous format incorporating signal conducting fibers controlling and or collecting data from spread along the strand. Strands of linear disposed sensing elements may be strung like a wire over a field or following a fence line. Synthetic conducting or semiconducting polymers may be used as substrate or support and may be woven, braided, interwoven into stretchable bands or fabric. The polymers themselves may comprise significant elasticity and strength minimizing or eliminating necessity for additional supporting structures.

The outputs of each NSE may be individually wired to a dedicated data transducer or a selection of sensor outputs may use a common carrier circuit and thus be “averaged”. In some embodiments, a simpler circuitry may involve multiple elements feeding a single output that may sum the outputs to deliver an average reading. When one or more of the “averaged” sensors is turned off or powered down, the average will not include output from these one or more powered down sensors. When input sensors are powered individually, for example, in a cycling pattern when only one (or a selected portion) of the input electrodes being charged, averaged outputs synchronized with the timing of input charging can thus provide data from individual channels.

The single output may connect and thereby collect data signal from any desired fraction of elements. For example, a single output may receive signal from all elements on a chip, half the elements on a chip, one-third the elements on a chip, a quarter the elements on a chip, a fifth the elements on a chip, and so on, for example, ⅙, 1/7, ⅛, 1/9, 1/10, 1/12, 1/20, 1/25, 1/33, 1/50, 1/100, etc. Any output may be associated with 1, 2, 3, 4, 5, 6, 7, 8, 9, 10, 11, 12, 13, 14, 15, 16, 17, 18, 19, 20, 21, 22, 24, 32, 48, 50, 64, 96, 100, 128, 200, 250, 256, . . . , 500, 512, 1000, 1024, 2048, 4096, 5000, 8192, 10,000 (10⁴), 16,384, 2¹⁵, 2¹⁶, 10⁵, 2¹⁷, 2¹⁸, 2¹⁹, 10⁶, 2²⁰, total number of sensors active on a chip which may vary with time or programmed instructions. The precise count of sensor elements associated with any output, in general, is a design feature and does not define operative functions of the invention. The counts specifically exemplified above are exemplary low numbers of sensors that may feed an output and higher numbers common in conventional plate assays and powers of 2 and 10 frequently used or approximated in biological or chemical science or physics or electronics. The sensor elements are preferably nano-sensor elements (NSEs) to minimize size and maximize sensitivity of the sensing chip. NSEs will in general be mounted or carried on a substrate or support matrix forming a “chip”. Individual matrices may feature multiple elements, generally 10 or more, 32 or more, 50 or more, or larger populations of elements on a single chip. As a rule, a greater number on a chip promotes a compactness desired for minimizing weight and size. The number of NSEs is a design feature and can mimic numbers familiar to the operator or data analyst. For example, multiple of the number of wells common on petri dishes may facilitate using existing software tools to further analyze and compare results. Powers of ten, multiples of a hundred, or thousand, powers of two are in common use. Accordingly, about 96 elements, 100 elements, 128 elements, 144 elements, 200 or 256 elements, 500 or 512 elements, 10³ or 2¹⁰ elements, 10⁴, 2²⁰, 10^{6,} etc. may be built in as common useful working populations even if several elements on the chip are not activated.

NSEs carried on the chips can be any properly designed sensing surface capable of, for example, field-effect transistor (FET) or other physico-electrical property/activity including, but not limited to: semi-conducting nano-wires, carbon nano-tubes—including single-wall carbon nano-tubes (SWNTs), chitosan-cantilever based, synthetic polymers—including dendrimers, plasmon resonance nano-sensors, Förster resonance energy transfer nano-sensors, vibrational phonon nano-sensors, optical emitting, optical frequency (or wavelength) based nano-sensors (sensitive to photon transmittance, absorption, reflection, energy modulation, etc.). Nano FETs and other nano-sensor formats generally operate by changing electrical properties as a substance comes in close proximity to the sensor by perturbing the steady state (absent the proximal substance) charges and movements (distribution of electrons) within the nano-sensor. When the transistor effective electrical properties cause an observable change in electron flow (current) this manifestation is one example of sensor competence. The altered distribution of electrons, depending on the design of the nano-sensor, changes one or more electrical properties, e.g., impedance, resistance-conductivity, capacitance, inductance, etc. and thus the physical movement of a detectable particle, e.g., an electron, a photon, etc. Minor variances in sensor sensitivities may be weighted internally by the machine learning software or may be overcome by averaging signals of a subpopulation of chips. This massaging feature is available as a tool to promote inter-device and/or inter-chip consistency.

Multiple populations of devices may act in concert. For example, if a collective of farmers, a farm bureau, a sponsoring organization, a seed supplier, or other entity with shared interests installs systems in a plurality of sites or fields. A central processing unit may be integrated to share and analyze communications from disparate locations. Such data may suggest a greater targeting area for mitigation as well as requests to neighbors or a local farm agent, for example, a county farm agent, to instigate more aggressive and dispersed mitigation efforts. Such data might also simply catalogue migration of a pest or might provide data showing a correlation of local weather to crops. Such data should be more helpful in assessing present threats when commensurate in time with comparative data. When distance is negligible, concurrent data would be preferred. Frequent observations on a schedule or in response to detected events or near continuous data collection will improve confidence in report outcomes. However, time differences or time lapses in obtaining data for comparison, do not significantly reduce benefits of analysis so long as conditions have not changed greatly. Outputs from several fields may be compared to assess effects of attempted mitigations and suggest timing and or component steps for optimizing yields. Commensurate in time sampling may be optimized when time is related to start, progression, or termination of a condition affecting different fields at different times. For example, in a hilly area, temperatures may vary with altitude resulting in temperature effects correlating with altitude. A commensurate time may thus be chronological separate but matching in experiencing a temperature event, like a frost. A rainfall may impact different fields as the storm progresses across an area. Presence of pollinating or herbivorous insect may have a time difference based on insect travel time, wind direction, deposit of hives, etc. Thus, any event of significance (changing plant growth of ambient environment), may serve as a time marker for “commensurate in time” data.

When an algorithm recognizes an event trigger, e.g., a sunrise, a rainfall, a pest arrival, etc., historical assessments may involve comparisons of the present with experiential data. Response to the event may be anticipated by the algorithm and when the present analysis session deviates from historical lessons, additional analysis or mitigation efforts may be commenced.

Sensor placements at a low density throughout a cooperation area can serve as sentries that when activated by identification of one or more factors compromising crop health and advise where additional sensors would be most beneficial. Algorithms for such sentry operations would ride above the algorithms involved in signature recognitions. Additional sentries might be delivered manually from air or ground, by an automated ground-based delivery module or using a drone delivery system.

A collective of farmers may agree to share all information with other members in the group, or an overseer may share conclusions or anonymized collections of data. Such overseer may comprise a plurality of individuals, such as a committee or board, may comprise a trusted individual, may comprise a set of instructions (algorithm) or other agreed upon referee.

One format discussed as an illustrative example herein involves use of carbon-based structures having properties similar to decorated single wall nanotubules (SWNTs). The carbon component atoms of the nano-tubules are receptive to complexing with ringed chemical structures (decorations or functionalizations). These complexes are often mediated through a non-covalent π-bonding effect.

Graphene, having similar single layer carbon geometry, with proper decoration, can also serve as a sensing surface. Evidence indicates the curved carbon structures of the SWNTs demonstrate more consistent FET properties in many use environments with various functionalization (decoration). Therefore, curved graphene, possibly formed into a corrugated or spiral geometry, (See, e.g., Michael Taeyoung Hwang, et al., Ultrasensitive detection of nucleic acids using deformed graphene channel field effect biosensors. Nat Commun 11, 1543 (2020). https://doi.org/10.1038/s41467-020-15330-9) may demonstrate more promising specificity, speed of analysis, and/or sensitivity over planar graphene for particular applications. As nanotechnology continues to progress additional sensor formats such as those emitting light, will become accepted in the art. Embodiments of the present invention may incorporate these improved sensors as their reliability is established. The skilled artisan will generally choose which form of sensor is optimal for performance and cost.

In addition to the field effect electrical sensing set forth as an exemplary embodiment, other qualities of thin carbon based used for sensing are possible. Optical, electrochemical or electrical features have been employed with graphene-based biosensors. Forms of graphene have been successfully tested for electrochemical (amperometric, voltametric, impedimetric, or combinations thereof) and electrical sensing applications. Selected formats have the high electron transfer rate, the high charge-carrier mobility and manageable electrical noise that is necessary for sensitive detection of biomarkers and other biological analytes. Successful assays have been reported in both serum and blood extracts. Optical transparency of graphene monolayers allows use in sensors such as optical-based G-biosensors.

Graphene sensors may be configured as flat, i.e., essentially planar, save for the bend introduced by the chemical bond angles or may be processed to exhibit a thicker, more three-dimensional structure, for example, a folded, rolled or crumpled graphene. Graphene surfaces may exhibit increased porosity by including gaps or perforations, i.e., discontinuous non-sensor layer portions interspersed within a continuous mesh of structural and/or sensing capable material. Such gaps or perforations may be regularly sized and spaced or may be pseudo-randomly distributed during synthesis. Within a module, layers may incorporate different formats such as synthetic polymer, SWNT, etc.

Graphene, especially mesh graphene, has additional advantages. Forms of graphene may serve as a structural substrate when incorporated into fabric or other shaping or support structure. Especially mesh graphene has been found to have strength several multiples that of steel with a relatively low density and a flexibility, deformability, and compliance with stretch available from the mesh structure.

Data from a plurality of devices, preferably from a large plurality of individuals may be collected and processed to reveal correlative occurrences. For example, data may suggest that one or more combinations of sensed factors, including concentrations, rate of increase, positive and negative correlations, ratios, time delays, activity levels, subject reports, etc., are predictive of or related to beneficial or hazardous outcomes. Such finding obtained in application of artificial intelligence may be instructive in managing subsequent events. A person with similar sensing devices reporting a relevant group of data may receive feedback perhaps to cease, increase, decrease, or modify activity or location to increase performance or to prevent injury to self or others.

Such agglomerated data may be applied in advisory, diagnostic or operational settings, for example, as indicative of environmental or pest induced stress. Such events may be communicated to an overseer so that appropriate action may be considered, may be communicated to a working group, may be communicated to a government employee or agency, may communicate with a supplier for delivery of defensive product, etc. Events meeting a predetermined criterion may serve to activate machinery to destroy or protect the compromised field.

The invention is designed to operate advantageously in that actual identification of relevant VOCs is unnecessary. This is analogous to the canine olfactory system. Some VOC elements may be programmed in indicative of known and immediate hazards. Some preprogrammed VOC elements may serve to identify the species under analysis.

The present invention involves a learning phase. In this phase, a number of different presentations of healthy plant variety are assessed. Data from multiple reads are processed and memorized (stored in memory) as indicative of a healthy crop. These data include multiple reading from a variety of locations and possibly a variety of strains. Locations and strains are stored as features that may signal where variances in signatures are acceptable and possible factors that might be applied to other locations or strains. VOC features common across several sample conditions are stored as signature in the learned memory. VOCs that appear in only some of the test samples are saved for potential future analysis, but are not considered relevant to assessing the product health.

In any application, ambient noise may be reduced when sensing elements are placed in different areas. Outputs from sensors at the level of plants (between ground level to just above plant height may be compared with outputs from sensors disposed at higher levels. VOCs from nearby fields, polluting factories, roadways, forests, etc. can then be accounted for in the data processing. Where different portions of a plot receive relevant different ambient influences, e.g., near a road, river, pesticide application, herbicide application, fertilizer application, irrigation, historical aberrations, location, temperature, time of day, type of crop, seed source, historical use of the field, solar radiation, cloud cover, pH, soil moisture, nitrogen concentration, phosphorus concentration, date of planting, crop price, conditions in comparison crop dispositions, rainfall, weather forecast, and windshear, etc., plant analysis and health may benefit from considering such influences when targeting sensor disposition.

A further learning phase may also serve as an operational phase. A deviation from the healthy signatures may naturally occur. The system then reports this deviation as an “event” for possible intervention. In some instances, the event may be recognized as related to other data, for example, the number of cloud-free or sun-free days. Similarly, the art has recognized several flags that are indication of known plagues. For example, a test sampling session may. have been run after spiking with 4-vinylanisole or other VOC or pheromone recognized as signatures for a specific circumstance or species. Resulting signatures may be used to advise specific action without additional machine learning.

The machine learning phase preferably includes sensing VOCs from a stressed field. Such fields are used as testing fields by seed companies to check for resistance against certain pests or to test effectiveness of defensive activities or chemicals relevant to that crop or seed strain. When the stressor is known, the VOC signature associated with that crop and stressor can be incorporated into the learned memory.

Another learning phase may involve delivery of devices to areas of known stress or expected stress, such as a recognized pest infiltration, in expectation of a seasonal infiltration or in the path of a spreading infiltration. The sensors collect data relevant to VOCs present. An absence of a VOC common in healthy fields may be incorporated into the learned memory the memory center species may then be associated with the signature(s) and retained in the memory center for subsequent searches.

Importantly, the invention collects data from the ambient surroundings of the plant or field of interest, subtracts or ignores data that is not relevant to specifics of the plant or field, forms signatures of the remaining relevant VOC data, compares these signatures to those in learned memory, and reports similarities with tagging or data relevant to the matches. Absence of an input, e.g., one or more VOC concentration below a predetermined threshold, a temperature range, a sound associated with a pest, etc., may be included as an element in a signature.

Where matches are imperfect signatures are compared for similarities that may suggest the stress source, e.g., a fungus, an insect, a type of insect, a plant competing with said crop for space or nutrition (weed), the part of the plant under attack, etc. Intensity of signatures or of specific factors involved in producing the signature may be used to indicate the stage of infestation and suggested mitigation actions.

Where particular pests are endemic in or expected to arrive or erupt in an area, the system may feature mitigation tools. For example, a dispensing feature may be activated in response to a recognized signature. Dispensed compounds are not limited. For example, dispensers may dispense a colorant or other indicator as a signal to promptly harvest or avoid harvesting an infested area. When the system recognizes defensive pheromones released in an area, the effect may be amplified by dispensing additional amounts and dispensing to neighboring areas. When susceptible pests are detected the system may dispense pest pheromones to confuse or interfere with inter-organism signaling, dispense compounds that attract carnivores for that pest, or apply pesticide locally to the infested area. Mitigation tools are not limited to chemicals. For example, when interfaced with photo emitting or sound emitting modules, light of a desired color, timing, or cyclic pattern may serve to attract desired pest predators, interfere with the pest diurnal needs, or to repulse the pest; sound may serve to mitigate damage, for example, by substituting for or inducing confusion into insect communications or by attracting birds or other animals to feed on the detected pest(s). Mitigation can be concentrated where needed to reduce costs and potential environmental damage.

Continual monitoring of a field producing at least a time lapse picture of the signatures may be instructive as to whether a plant's natural responses are active and may be sufficient or whether outside intervention may be beneficial. This system is also applicable to assessing plant maturation on a finer scale than satellite data. Slowed or accelerated maturity may be indicative of a particular stress or of one of a family of stressors. Successful pollination levels, presence of pollinating insects and/or timing for delivery of pollinating insects are other outputs available from more continuous readings taken with devices of the invention.

Harvesting can be optimized by monitoring plant maturation or spreading infestations and scheduling harvesting at desired maturity or to minimize pest damage. In extreme events the results of the invention may suggest eschewing harvest of a field or portion thereof and possibly even destruction of that crop to minimize future damages.

In a controlled environment as encountered in greenhouses or on vertical farming, the invention may be programmed to speed or slow maturation to ensure freshness based on recent or anticipated demand. Maturation control may start at the determination of when to plant, but may be later invoked, for example, to maximize weekday, payday, weekend, or other delivery spike. Individual shelves or zones of shelves may have fuel, lighting, timing of lighting, light wavelengths, temperatures, hydration, or other factor controlled in response to analytical output from sensed data.

Sensors may be motile, e.g., on a robot traversing through a field, a tractor, an irrigation device, a drone, etc. Motile sensors provide instruction to carriers on amounts and types of mitigations to take. Water volume may be more precisely and more timely delivered using sensor outputs; plant feeds and/or pesticide may be selectively and volumetrically delivered where most beneficial. For example, phosphates or nitrates may be selectively delivered decreasing polluting runoffs while producing enhanced yields.

Low flying drones may serve as motile carriers. These may be especially useful for obtaining survey data. Signatures of specific pests, diseases, weeds, and/or growth and development may be detected in a generalized flyover. A drone will be equipped with a geolocator whose output when coupled with sensor data in real time or correlated using stored data will provide a degree of localized information. Regions or smaller zones may be evaluated and compared. Such data may be used when a “big picture” assessment might be useful. When VOCs are associated with specific flora or fauna, numbers, healths, and potential adverse outcomes may be foreseen or prevented. Information obtained from sensory overflights may be used to direct optimal disposition of ground-based sensors, perhaps by aerial drop, instructions to ground crews or aerial based post installation. associated memory center, data obtained from general sources (e.g., a calendar, a clock, a rain gauges, a humidistat, ozone detector, photocell, a microphone, etc.), data from comparative sensing devices or locations, etc. During a learning phase VOC and other data are processed to identify signatures relating to a plurality of conditions. A memory center catalogues such signatures for future processing and analysis. Signature data in the memory center is refined as additional data are collected. At least one algorithm is applied to generate at least one signature associated with one or more or a group or plurality of conditions associated with each signature. Continued algorithmic processing then delivers the at least one signature for comparison with signatures resident in the memory center. Algorithms may be updated with each refinement or with batches of refinements. Signatures and/or refinements may be associated with individual conditions or with collections of conditions including, but not limited to: a stage of growth or development of said crop; a pest capable of attacking said crop; a microbiome associated with said crop, hydration status of said crop, an organism competing for space or nutrition with said crop, a defense signal release from said crop, a chemical attractant for a pest, a defensive chemical emitted by a pest, and response of said crop to one or more infestation mitigating strategies, etc.

After algorithms have been developed and verified, new batches of VOC sensor-derived and other data sources are processed to produce signature(s) relevant to identified condition(s). One or more condition may be categorized by VOC sensor or other sensor data. Such signature(s) are compared to signatures from the memory center to determine matched signatures and associated these with conditions. Matches are flagged and conditions associated with the new signature(s) are outputted. When matches are uncertain or below algorithmic identified threshold, the system then may consider signatures with similarities to the new signature(s). For example, a subset of VOCs may match, but one or more data points may prevent a full signature match. Commonalities of the subset, e.g., hypothetically, green insects with middle legs shorter than front and back, size less than 0.05 mm length, and a hum in a frequency of 68,000 to 88,000 Hz. But the six insects known with these characteristics each produce a unique VOC that is not present in the new sample. Similarities suggest a grouping or genus. Additional data show this genus to include 16 species which leaves 10 species with absent or inadequate signature data. Additional data, physical samples, photographic, genetic, etc., may then be collected for taxonomic analysis. One of the 10 known species or a new to library as indicative of the presented stress. VOCs associated with the signature thus may appear as a reduction in signal from one or more sensing elements or as additional VOCs. Novel VOCs or novel levels of VOCs are flagged and incorporated into the learned memory relevant to that stress.

The pattern of output of one or more sensors is the relevant signature component for incorporation into the learned memory library. The system has no need to know the identity of the compound or even its elemental constituents. The interaction of the unknown(s) with the sensor elements and correlation (pattern recognition) of a signature of the activities of the sensors in the presence of the stress is sufficient to characterize the stress. Identifying the sources of the VOC compounds is not required. Only the signals produced by the sensor components is necessary to construct the relevant VOC signature. Whether the relevant changed VOC level is plant produced, plant microbiome produced, pest produced, pest predator produced, etc. is not a required element in constructing a valid useful signature. Crop scientists may be interested in these data to learn more about the biochemistries, but the invention is fully operational and beneficial without identifying and naming the chemical components. This process thus shares advantages of using animal olfactory systems including specialized olfactory memories but is more repeatable with fewer variables and a better understood and controlled training process. Unlearning procedures as might be desired when a random reward or nociception affects an animal's training can be extremely difficult. The present invention allows human intervention simply by eliminating or downgrading a sample or sample result.

Learning is further enhanced when the sensing device encounters a novel measuring event. VOCs sensed in the novel field are analyzed for a match with healthy or stressed signatures. An absence of healthy signatures would inspire the machine learning process to look for similarities of the observed to learned memory signatures. Similarities may be instructive of what type of pest is stressing the plant. For example, at a high level, the similarities may suggest the stress is more probably fungal than insect or possibly a phage attacking a beneficial bacterium in the plant's microbiome. An antifungal treatment may then be suggested; or perhaps spraying with a healthy plant derived microbiome bolus.

In the field, a data processor receives data from a plurality of sensing inputs. VOC data may be combined with other data sources, including data that may already be resident in an

And where the associations of distinct sets with each crop or condition and differences i between distinct sets associated with different crops or conditions are used in an AI protocol to form a signature pattern indicative of the crop or condition.

Where a crop or condition may including, but not be limited to: a stage of growth or development of a crop; a pest capable of attacking a crop; a microbiome associated with a crop, hydration status of the crop, an organism competing for space or nutrition with the crop, a defense signal release from a crop, a chemical attractant for a pest, a defensive chemical emitted by a pest, and response of the crop to one or more infestation or infestation mitigating strategies.

Where signature elements associated with different crops or conditions and not associated with said first crop or condition are recognized'.

Where distinct data in addition to data indicating interactions of a VOC sensor with one or more VOCs are obtained and these distinct data are incorporated into a memorialized signature in a form available for comparison with a second or subsequent signature.

Where distinct data might include at least one factor relating to a condition selected from the group consisting of: location, proximity to a road, proximity to a river, historical pesticide application, historical herbicide application, historical fertilizer application, available irrigation, historical irrigation, temperature, time of day, type of crop, seed source, historical use of the field, solar radiation, sound, cloud cover, pH, soil moisture, nitrogen concentration, phosphorus concentration, date of planting, crop price, conditions in comparison crop dispositions, rainfall, weather forecast, and windshear.

Where at least one algorithm that identifies signatures indicative of at least one condition having an associated signature in said library is formed and the algorithm compares such signature to at least one signature in said library so that when a match is indicated a result suggestive of the match with at least one associated condition in said library is outputted; and when no match is indicated, several inconclusive matches of conditions are compared to identify shared characteristics of the conditions with the strongest matches, and to suggest at least one genus of conditions with shared characteristics, including recognizing species, if any, of said genus that may at that time lack a signature.

Where additional data from a location relevant to the environment encompassing the source of data for which no match was identified are collected.

Where one or more conditions in said location or in a part of said location; and

then recognizing and assigning a signature to be associated with each of said one or more conditions or with a plurality of said one or more conditions.

Where multiple signatures are compared from a first crop or condition to tabulate similarities and differences of said multiple signatures and to assign a probability value to each similarity and difference so that the probability value may be introduced into an algorithm for reporting the crop or condition as a product of detecting and analyzing multiple factors that affect one or more crops.

Where data are collected over a time span of minutes, hours, days, months, seasons years, etc. including, but not limited to: a planting, a rainfall, a sunrise, sunset, pesticide application, herbicide application, arrival of pest, fertilizer application, irrigation, temperature threshold, time of day, sequential crops in the field, cloud cover, pH adjustment, dew, and/or windshear event.

Where repeated operations of the method delivers data that adjust at least one probability value.

Where adjusted probability values are applied in an algorithm.

Where signature data are compiled with data obtained at different times.

Where data are obtained from a continuing crop season.

Where data are obtained from different crop seasons.

Where the method may comprise a third signature obtained from data commensurate in time with said second signature, said second and third signatures obtained using data from crops separated by distance.

Where crops separated by distance serve as economic substitutes.

Where a less than optimal signature pattern of a crop is selected as indicative for performing at least one mitigation factor selected from the group consisting of: pesticide application, herbicide application, fertilizer application, irrigation, historical irrigation, shading, increasing exposure to solar radiation, emitting a sound, emitting light, modifying pH, altering soil moisture retention, feeding microbiome, harvesting, thinning, draining, etc.

1. A method for detecting and analyzing factors that affect at least one crop of interest, said method comprising:
i) analyzing data produced by a plurality of interactions of a VOC sensor with at least one VOC;
ii) said analyzing comprising associating at least one VOC with a concentration range of said at least one VOC;
iii) identifying said associating as indicative of a condition of said at least one crop;
iv) tagging said identifying with said condition thereby forming a signature indicative of said at least one crop and said condition; and
v) memorializing said signature in a form available for comparison with a second or subsequent signature.

2. The method of claim 1 further comprising:
vi) comparing said second signature to said memorialized signature.

3. The method of claim 2 wherein said second signature is associated with a second condition.

4. The method of claim 3 further comprising:
vii) memorializing said second signature in a form available for comparison with a third signature.

5. The method of claim 2 wherein said comparing is indicative of said tagged condition and tagging and memorializing said second signature as being associated with said condition of iii).

6. The method of claim 1 further comprising a plurality of repetitions of i) through v) to form a compilation of signatures tagged as indicative of a condition of at least one crop and memorializing said compilation as a signature library.

7. The method of claim 1 further comprising comparing said memorialized signature with a plurality of signatures resident in a signature library and reporting tagging of associations with signatures tagged as indicative of a condition of said at least one crop.

8. The method of claim 1 further comprising obtaining distinct data in addition to data indicating interactions of a VOC sensor with at least one VOC and incorporating said distinct data into a memorialized signature in a form available for comparison with a second or subsequent signature.

9. The method of claim 8 wherein said distinct data includes at least one factor relating to a condition selected from the group consisting of: location, proximity to a road, proximity to a river, historical pesticide application, historical herbicide application, historical fertilizer application, available irrigation, historical irrigation, temperature, time of day, type of crop, seed source, historical use of the field, solar radiation, sound, cloud cover, pH, soil moisture, nitrogen concentration, phosphorus concentration, date of planting, crop price, conditions in comparison crop dispositions, rainfall, weather forecast, and windshear.

10. The method of claim 1 wherein said condition is selected from the group consisting of: a stage of growth or development of said crop; a pest capable of attacking said crop; a microbiome associated with said crop, hydration status of said crop, an organism competing for space or nutrition with said crop, a defense signal release from said crop, a chemical attractant for a pest, a defensive chemical emitted by a pest, and response of said crop to one. or more infestation mitigating strategies.

11. A system for detecting and analyzing factors that affect at least one crop of interest, said system comprising:
i) a data processor;
ii) a plurality of nanosensing elements interfaced with said data processor to deliver data thereto, said plurality of nanosensing elements comprising multiple nanosensing elements nanosensitive to one or more VOCs being in close proximity to the nanosensing element;
iii) a memory center receiving output from said data processor, said memory center memorializing a library of signatures indicative of a condition selected from the group consisting of: a stage of growth or development of said crop; a pest capable of attacking said crop; a microbiome associated with said crop, hydration status of said crop, an organism competing for space or nutrition with said crop, a defense signal release from said crop, a chemical attractant for a pest, a defensive chemical emitted by a pest, and response of said crop to one or more infestation mitigating strategies.

12. The system of claim 11 wherein at least one nanosensing element comprises a VOC interactive surface selected from the group consisting of: semi-conducting nano-wires, carbon nano-tubes—including single-wall carbon nano-tubes (SWNTs), chitosan, and synthetic polymers—including dendrimers.

13. The system of claim 11 wherein said plurality of nanosensors comprise nanosensors disposed at a variety of heights selected from the group consisting of: subterranean, stalk height, stem height, leaf height, and above crop height.

14. The system of claim 11 further comprising an interface between multiply disposed arrays of nanosensing elements.

15. The system of claim 14 wherein said multiply disposed nanosensing elements act in concert through at least one central processor.

16. The system of claim 15 wherein said multiply disposed nanosensing elements are under direction of an organizer selected from the group consisting of: a collective of farmers, a farm bureau, a sponsoring organization, and a seed supplier.

17. An implantable post supporting VOC nanosensing elements, said post comprising VOC nanosensing elements at multiple heights.

18. The post of claim 17 wherein said nanosensing elements are incorporated into at least one arrangement selected from the group consisting of: a strip, a band, and a pod.

19. The post of claim 17 wherein said nanosensing elements are disposed at at least one height selected from the group consisting of: subterranean, stalk height, stem height, leaf height, and above crop height.

20. The post of claim 17 wherein said post is capped with an energy collector.

21. The post of 20 wherein said energy collector is selected from the group consisting of: a photocollector and a turbine.

22. The post of claim 17 comprising telescopic members.

23. The post of claim 17 further comprising a data processor.

24. The post of claim 23 further comprising a feature selected from the group consisting of: a communication portal, a video camera, a microphone, a thermometer, and a hydrometer.
